(19) United States
(12) Patent Application Publication
(10) Pub. No.: US 2010/0257234 A1
(43) Pub. Date: Oct. 7, 2010

(54) METHOD AND APPARATUS FOR PROVIDING CONTENT TO MOBILE RECIPIENTS

(76) Inventor: David CAUGHEY, Ottawa (CA)

Correspondence Address: FREEDMAN & ASSOCIATES, 55 Murray Street, Suite 230, Ottawa, ON, K1N 5M3, CA

(21) Appl. No.: 12/752,202

(22) Filed: Apr. 1, 2010

Related U.S. Application Data
(60) Provisional application No. 61/166,276, filed on Apr. 3, 2009.

(51) Int. Cl. G06F 15/16

(52) U.S. Cl. 709/203; 709/227

(57) ABSTRACT

A method is provided for providing audio content to a user, the user being uniquely associated with a mobile communications device that is in wireless communication with a host system via a communications network, the method comprising. The method comprises receiving from the user via the communications network a request for audio content relating to a known point of interest (POI). The request includes a unique user identifier associated with the user and a unique POI identifier associated with the known point of interest. Profile preference data are retrieved from a first storage device of the host system, the profile preference data being stored in association with the unique user identifier and relating to at least one predefined preference of the user. A first audio content fragment is retrieved from a second storage device of the host system, the first audio content fragment selected from a plurality of available audio content fragments in dependence upon the retrieved profile preference data and the unique POI identifier. The retrieved first audio content fragment is then provided to the user via the communications network the.

### FIELD OF THE INVENTION

The instant invention relates generally to mobile information systems, and more particularly to a method and apparatus for delivering customized and/or dynamic content to a mobile recipient.

### BACKGROUND OF THE INVENTION

A number of methods have been employed for the purpose of presenting visitors with information that is related to various points of interest, such as for instance exhibits (e.g., art displays, zoological displays, and the like) or sites (e.g., tours of historic sites, natural wonders, urban settings, theme parks, sports venues, and the like), which are in the proximate vicinity of the visitor. For instance, guided tours are offered in which a human tour guide accompanies a visitor or a group of visitors on a walking tour or in a vehicle. The tour guide provides information and additionally is able to answer questions and expand upon points that are of particular interest to one or more of the visitors. Furthermore, the tour guide may choose to present the same information in different ways or using different formats, depending upon the age and/or other interests of the visitors, etc. Unfortunately, the accuracy and the bias of the information provided to the visitor are highly dependent on the tour guide. In addition, typically different tour guides must be employed if tours are to be conducted in different languages, and each tour guide can provide services to only a limited number of visitors during each tour. Accordingly, guided tours have high on-going costs while they benefit only a relatively small number of visitors to an exhibit or site.

Self-guided tours are also known, in which a visitor reads information that is printed onto signs or plaques that are displayed near various exhibits and/or other points of interest. Optionally, the physical signage is supplemented with or is replaced by printed brochures, which are carried around by the visitor as they move through an exhibit or site. Different versions of the brochure may be made available to the visitor. For instance, the visitor may be able to select between brochures that are printed in different languages and/or brochures that contain information that is targeted at different age groups, etc. Advantageously, the cost that is associated with setting up and maintaining a self-guided tour is lower than the corresponding cost for a guided tour. A self-guided tour also allows the visitor to proceed through an exhibit at their own pace, spending more time at points that are of higher interest and less time at points that are of lower interest. Unfortunately, the printed information is static and there is little or no opportunity for the visitor to supplement this information. Furthermore, the visitor must be capable of reading the printed information or they must have the information read to them. Accordingly, traditional self-guided tours are not well suited for younger visitors and/or visually impaired visitors and are not easily customized or expanded.

Attempts have been made to improve upon the self-guided tour experience by replacing the printed brochures with portable playback devices. In such systems the visitor is required to rent a portable playback device at the beginning of a tour, which typically involves paying an additional fee or providing a deposit or identification, and then returning the portable playback device at the end of the tour. Audio and/or video content is provided to the visitor as they move around and explore the exhibit. For instance, the portable playback device is configured to trigger short-range infrared (or similar technology) transmitters that are located at various points of the exhibit and play back a description that is keyed to the location of the transmitter. Optionally, the visitor uses a keypad to enter a code that is associated with a point of interest, causing retrieval and playback of content that is stored in association with the code. In an alternate approach the content is stored within the portable playback device, e.g. on a disc or on another suitable optical, magnetic or solid-state storage medium.

The use of a portable playback device supports the delivery of content that is more fully immersive, such as for instance first person accounts, dramatic re-enactments, sound bites, etc. Some systems even use a menu-based approach to allow the visitor to select additional information to supplement the basic information that is provided. Unfortunately, the information that is available within the menu structure is static. In addition, the use of portable playback devices or portable receiver devices requires an initial capital investment and on-going maintenance expenditures for an exhibit or site. Furthermore, it is an inconvenience to the visitor to have to rent the necessary equipment at the beginning of a tour and then return the equipment at the end of the tour, and for the operator of the system to distribute, collect, clean, recharge and repair the equipment as necessary.

More recently, self-guided tours have been implemented using a system that allows visitors to use their personal mobile telephone (e.g., cell phone) to dial a telephone number that is associated with an exhibit. Visitors subsequently enter a code, using the telephone keypad, to cause selective retrieval and playback of audio and/or video information that is relevant to their current location. Typically, the necessary codes are posted on signs at various points of the exhibit. Alternatively, the visitor's current location is determined automatically using GPS (global positioning system), angle of arrival, or other similar information. Since visitors use their own mobile phone there is no additional equipment to buy/lease, store, clean, recharge, update or check in or out. Furthermore, the visitor may decide to make use of the self-guided tour system at any time during a visit, without being required to return to a desk or kiosk in order to rent the necessary equipment. Advantageously, the facility or exhibitor that is hosting the system may bill the visitor directly via the cellular telephone, and/or collect demographic data automatically, using for instance the caller ID function.

Unfortunately, the currently known mobile phone tour-guide systems fail to provide a truly personalized tour experience, despite the fact that each visitor to an exhibit or site utilizes their own cell phone to retrieve and play back content. Furthermore, the heretofore known mobile phone tour systems require the visitor to recognize points of the exhibit that are of particular relevance to their own interests, and then actively request additional and/or supplemental information relating thereto. Unfortunately, often it will be the case that the visitor is unaware of a potentially interesting feature or aspect of an exhibited piece, and therefore they will not know to request the additional or supplemental information. As such, each visitor is provided a relatively generic self-guided tour experience, with only limited capacity for customization.

Accordingly, there exists a need for a method and apparatus that overcomes at least some of the above-mentioned limitations.

### SUMMARY OF EMBODIMENTS OF THE INVENTION

According to an aspect of the instant invention there is provided a method for providing audio content to a user, the user being uniquely associated with a mobile communications device that is in wireless communication with a host system via a communications network, the method comprising: receiving from the user via the communications network a request for audio content relating to a known point of interest (POI), the request including a unique user identifier associated with the user and a unique POI identifier associated with the known point of interest; retrieving from a first storage device of the host system, profile preference data that are stored in association with the unique user identifier, the profile preference data relating to at least one predefined preference of the user; retrieving a first audio content fragment from a second storage device of the host system, the first audio content fragment selected from a plurality of available audio content fragments in dependence upon the retrieved profile preference data and the unique POI identifier; and, providing to the user via the communications network the retrieved first audio content fragment.

According to an aspect of the instant invention there is provided a method for providing audio content to a user via a mobile communications device that is in wireless communication with a host system via a communications network, the method comprising: receiving from the user via the communications network a request for audio content relating to a known point of interest (POI), the request including a unique POI identifier associated with the known point of interest; retrieving from a storage device of the host system a default first audio content fragment that is stored in association with the unique POI identifier; providing to the user via the communications network the retrieved default first audio content fragment; receiving from the user via the communications network a request for audio content that is supplemental to the default first audio content fragment; retrieving from the storage device of the host system a second audio content fragment that is linked to the default first audio content fragment; and, providing to the user via the communications network the retrieved second audio content fragment.

According to an aspect of the instant invention there is provided a system for providing audio content to a user, the user being uniquely associated with a mobile communications device that is in wireless communication with a host system via a communications network, the method comprising: for each point of interest of a plurality of different points of interest, providing to the user via the communications network at least one audio content fragment; determining for each point of interest of the plurality of different points of interest, a user interest score relating to the provided at least one audio content fragment; and, storing data defining a user preference profile, the data stored in association with a unique user identifier of the user, the data comprising first data based on the determined user interest score for each point of interest of the plurality of different points of interest.

According to an aspect of the instant invention there is provided a method for providing audio content to each user of a plurality of different users, each one of the users being associated uniquely with a different mobile communications device that is in wireless communication with a host system via a communications network, the method comprising: associating a first user of the plurality of different users with a second user of the plurality of different users; receiving from the first user via the communications network a request for audio content relating to a known point of interest (POI), the request including a unique POI identifier associated with the known point of interest; retrieving at least a first audio content fragment from a storage device of the host system, the at least a first audio content fragment selected from a plurality of available audio content fragments in dependence upon at least the unique POI identifier; and, providing the at least a first audio content fragment to the first user and to the second user, absent the second user providing a request for audio content relating to the known point of interest.

According to an aspect of the instant invention there is provided a method for providing tour-related audio content to a user, the user being uniquely associated with a mobile communications device that is in wireless communication with a host system via a communications network, the method comprising: defining a tour having a predetermined duration, the tour comprising a plurality of component tours that in aggregate have a total duration of less than or equal to the predetermined duration; receiving data relating to progress of the user through a first component tour of the plurality of component tours; determining an expected tour duration based on the total duration of the component tours and the received data relating to progress of the user through the first component tour; when the expected tour duration is greater than the predetermined duration, accelerating the delivery of tour-related audio content to the user, wherein the delivery of tour-related audio content is accelerated by an amount that is sufficient to decrease the expected tour duration to less than or equal to the predetermined duration.

According to an aspect of the instant invention there is provided a method for defining an audio-guided tour for providing audio content from a host system to a user via a communications network, the method comprising: establishing communication between a tour-creator's mobile communication device and the host system via the communications network; defining points of interest (POI) of the audio-guided tour, the defined points of interest selected from a plurality of known points of interest, each known point of interest having at least an audio content fragment stored on the host system in association with a unique POI identifier thereof, the selection of each of the points of interest being executed in dependence upon providing, using the tour-creator's mobile communication device, the unique POI identifier associated therewith; for each of the defined points of interest, selecting at least one audio content fragment that is to be provided during the audio-guided tour in response to the user providing a request including the unique POI identifier associated therewith; and, retrievably storing on the host system a record in association with a unique tour identifier of the audio-guided tour, the record comprising data indicative of the defined points of interest and of the selected audio content fragments.

### BRIEF DESCRIPTION OF THE DRAWINGS

Exemplary embodiments of the invention will now be described in conjunction with the following drawings, in which similar reference numerals designate similar items:

FIG. 1 is a simplified block diagram of an interactive audio guide service according to the prior art;

FIG. 2 is a functional block diagram of a Voice Application Server in an interactive information retrieval system, according to the prior art;

FIG. 3 is a functional block diagram of a Knowledge Server in an interactive information retrieval system, according to an embodiment of the instant invention;

FIG. 4 is a simplified flow diagram of a method according to an embodiment of the instant invention;

FIG. 5 is a simplified flow diagram of a method according to an embodiment of the instant invention; and,

FIG. 6 is a simplified block diagram showing a nested or hierarchal tour structure.

### DETAILED DESCRIPTION OF EMBODIMENTS OF THE INSTANT INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications. Thus, the present invention is not intended to be limited to the embodiments disclosed, but is to be accorded the widest scope consistent with the principles and features disclosed herein.

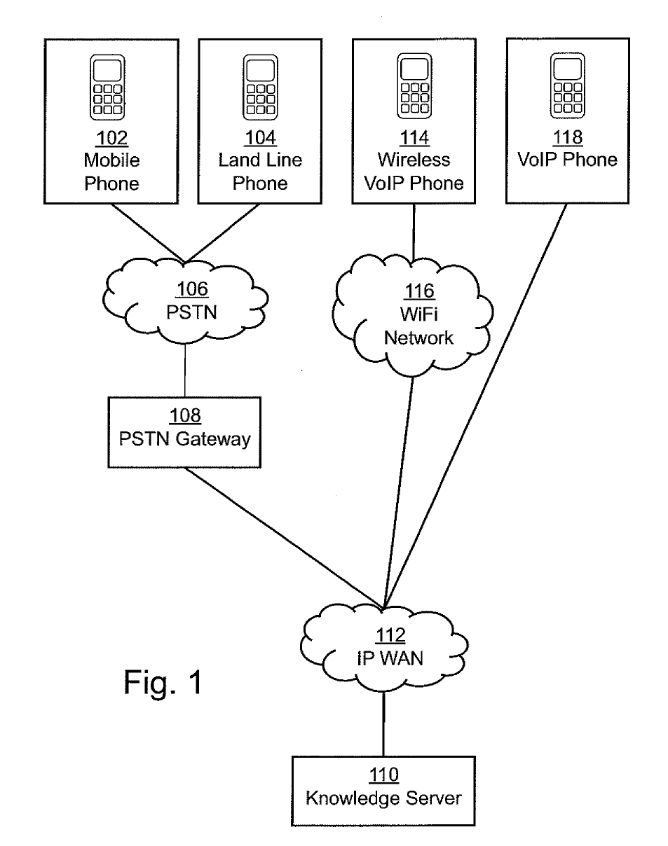

Referring to FIG. 1, shown is a simplified block diagram of an interactive audio guide service according to the prior art. A mobile phone 102 or a land line phone 104 initiates a call to one of a plurality of Direct-Inward-Dialing (DID) numbers. The existing Public Switched Telephone Network (PSTN) 106 routes the call to a PSTN Gateway 108, which converts the PSTN protocol and media stream to other VoIP protocols and media formats, such as for instance the Session Initiation Protocol (SIP) or the Session Description Protocol (SDP). The PSTN Gateway 108 then connects to a Knowledge Server 110 via the Internet-Protocol Wide-Area-Network (IP WAN) 112. Optionally, the interactive audio guide service is implemented directly on TDM hardware, thereby eliminating the need for the PSTN Gateway 108. Further optionally, VoIP protocols other than SIP or SDP are used, such as for instance XMPP/jingle, Skype, etc. Such protocols are essentially transparent in that a call and media stream initiated by a mobile device can be processed by software (i.e., the “Knowledge Server”) running on general-purpose computers.

Mobile phone 102 or land line phone 104 generate media, typically in the form of audio that is received through the phone's microphone and/or key-presses implemented either in-band or out-of-band via a protocol such as RFC 2833. Such audio is received by the PSTN Gateway 108 via the existing PSTN 106, and is possibly transcoded before being re-transmitted to the Knowledge Server 110 via the IP WAN 112.

Media generated by the Knowledge Server 110, typically in the form of audio content retrieved from stored files and/or generated via text-to-speech and/or sourced from other communication devices, is transmitted to the PSTN Gateway 108 via the IP WAN 112, whereupon it is possibly transcoded before being transmitted to mobile phone 102 or land line phone 104 via the existing PSTN 106.

Alternatively, a Wireless VoIP phone 114 initiates a call to a one of a plurality of Universal Resource Locators (URL's). The call is placed onto the IP WAN 112 via WiFi Network 116, and is subsequently routed to the Knowledge Server 110. Wireless VoIP phone 114 generates media, which is transmitted directly to the Knowledge Server 110 via the WiFi Network 116 and the IP WAN 112. Similarly, media that is generated by the Knowledge Server 110 is transmitted directly to the Wireless VoIP phone 114. Of course, when using VoIP phone 118 the path is the same as for the wireless VoIP connectivity, except that the VoIP phone 118 connects directly over the IP WAN 112.

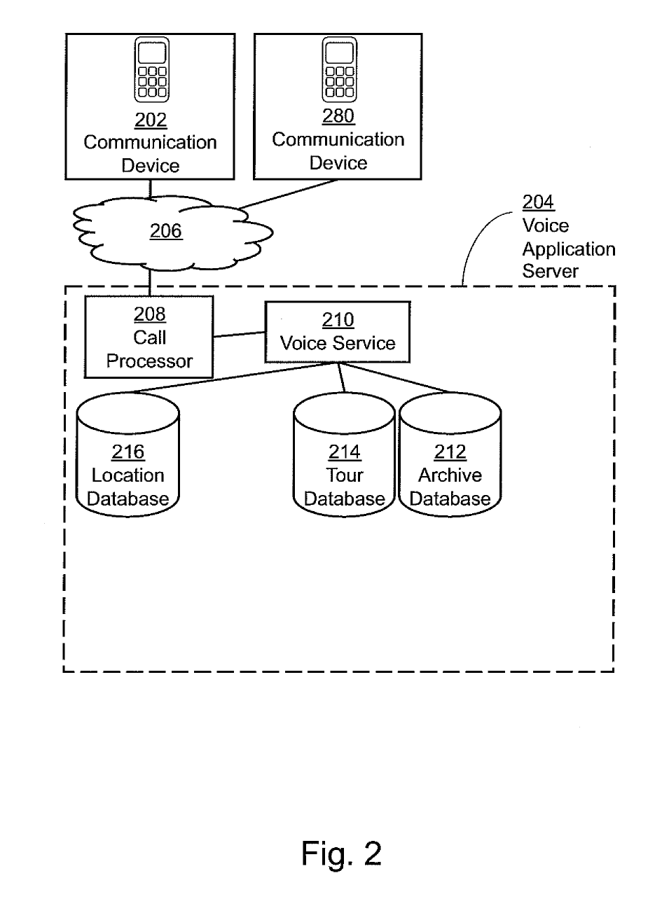

Referring now to FIG. 2, shown is a functional block diagram of a Voice Application Server in a prior art interactive information retrieval system. A communication device 202, such as for instance a cellular telephone or a landline phone, establishes a connection and bidirectional media path with Voice Application Server 204 via network elements 206, as was described in greater detail with reference to FIG. 1. A Call Processor 208, typically a SIP stack, manages the connection and directs media to a media-processing component, Voice Service 210, which can generate audio, interpret and react to key presses and audio inputs, etc.

Typically, upon establishment of a connection to Voice Service 210 from a communication device 202, the Voice Service 210 retrieves audio content that instructs the user of communication device 202 how to interact with the device. This audio content is then injected into the media stream that is being transmitted to the communication device 202. The audio content may be retrieved in a number of different ways, including referencing an in-memory copy of the audio content, reading a file from a file system, retrieving a record from an electronic database, or generating the audio content on-demand via a text-to-speech engine. Indeed, it often will be the case that a plurality of different methods are used to retrieve the audio content, in that audio content read from the file system may be subsequently cached in-memory, or the generated output of a text-to-speech engine may be written to a temporary file on the file system, etc.

The initial instructions to the user of communication device 202 typically prompts the user to interact with the communication device 202 by pressing keys, or by uttering voice commands, which are then transmitted to the Voice Service 210. Upon receipt of a key press, or a sequence of key presses, or voice commands, the Voice Service 210 accesses an electronic Archive Database 212, which maps the key presses or voice prompts into references to audio content that is then retrieved and injected into the media stream that is being transmitted to the communications device 202.

Upon completely injecting the retrieved audio content, the Voice Service 210 typically injects additional audio content that represents further instructions to the user of the communication device 202.

In addition to signals received from communication device 202, the Voice Service 210 may also react to other stimuli, such as for instance timers that are set by the Voice Service 210 itself. Such timers typically are set and cleared upon specific conditions, for example; the start of a session, a key press being received from communication device 202, audio content starting to be injected, audio content being completely injected, or upon the expiry of a different timer. In this manner, a Voice Service 210 can implement a variety of functionality, such as repeating an instruction to the user if no key presses have been received within 30 seconds (or another period of time) after the instruction was completely played, interpreting a sequence of key presses as being complete if no additional key presses are received within 3 seconds (or another period of time) of the last key press, interacting with Call Processor 208 to disconnect the call after 2 minutes (or another period of time), continuing to inject additional audio fragments if no interactions are detected within 5 seconds (or another period of time), etc.

Referring still to FIG. 2, in an interactive audio guide system a user calls into Voice Service 210 using the communication device 202 and is prompted to enter a point of interest (POI) identifier associated with a first point of interest, such as for instance a first artifact that is on display in an exhibit. In response to receiving the POI identifier the Voice Service 210 retrieves from Archive Database 212 audio content that describes the first artifact, and then prompts the user to enter another POI identifier for a second point of interest, such as for instance a second artifact that is on display in the same exhibit. This process is repeated for each point of interest that the user encounters, so as to support an “ad hoc” visit of an exhibit, site or facility, etc.

Alternatively, the Voice Service 210 is implemented such that upon completely injecting audio content describing the first point of interest, the Voice Service 210 queries an electronic Tour Database 214 for the next POI identifier in the tour, and retrieves location information for both the current point of interest and the next point of interest from an electronic Location Database 216. This information can then be used to generate or retrieve audio content that instructs the user as to how they may locate the next point of interest, followed by additional audio content instructing the user to press a key to indicate when they are ready to hear the description that is associated with the next point of interest. If there is no location information in the electronic Location Database 216 for the first point of interest and/or the next point of interest, then audio content stating the POI identifier of the next point of interest may be used in lieu of providing instructions for proceeding thereto. Thereafter, when the Voice Service 210 receives a key press or a voice command from the communication device 202, the Voice Service 210 retrieves the appropriate audio content from the electronic Archive Database 212 and injects the audio content into the media stream that is being transmitted to the communication device 202. Repeating this process for each one of a plurality of points of interest results in the presentation of a “guided” tour. Multiple guided tours through a same facility are easily supported. For instance, when the user initially establishes connection to Voice Service 210 they are prompted to provide a tour identifier code, either by entering a sequence of key presses or by uttering a voice command. Thereafter, the user is guided from one point of interest to the next according to a predetermined sequence of the selected tour. In particular, the tour identifier is used to query the electronic Tour Database 214 for the next point of interest in the sequence of the selected tour. Different tours may be geared toward different user demographics (i.e., different age groups, etc.) or toward different user interests.

Embodiments of the instant invention will now be described using a museum tour as a specific and non-limiting example. In the description that follows, the term “point of interest” is not intended to be limiting in any way, but rather it should be construed broadly so as to include any artifact, item or piece that is capable of being displayed to the public as part of an exhibit in a museum, gallery or other similar facility. Accordingly, the term point of interest is intended to include, but is not limited to, both natural and man-made objects, living and non-living specimens, paintings, sculptures, models and other works of art and/or creativity, historical artifacts, relics, books, etc., as well as reproductions and/or digital representations of any of the above-mentioned items, pieces, specimens or objects. In other implementations, the term “point of interest” also includes natural and/or man-made features, objects, etc. that are not parts of an exhibit in a museum, gallery or other similar facility. By way of specific and non-limiting examples, the term “point of interest” also applies to geological formations, historical sites such as buildings, battlefields, etc., vehicles, or even participants in athletic or other competitions, etc.

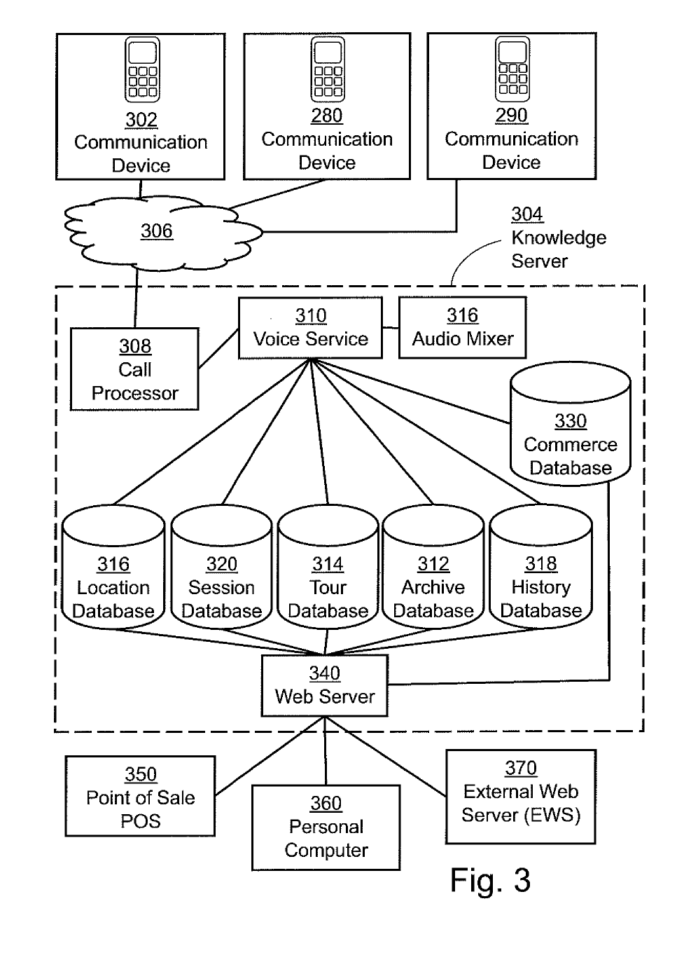

Referring now to FIG. 3, shown is a functional block diagram of an interactive audio guide service according to an aspect of the instant invention. A communication device 302, such as for instance a cellular telephone or a landline phone, establishes a connection and bidirectional media path with Knowledge Server 304 via network elements 306, as was described in greater detail with reference to FIG. 1. A Call Processor 308, typically a SIP stack, manages the connection and directs media to a media-processing component, Voice Service 310, which can generate audio, interpret and react to key presses and audio inputs, etc.

Typically, upon establishment of a connection to Voice Service 310 from a communication device 302, the Voice Service 310 retrieves audio content that instructs the user of communication device 302 how to interact with the device. This audio content is then injected into the media stream that is being transmitted to the communication device 302. The audio content may be retrieved in a number of different ways, including referencing an in-memory copy of the audio content, reading a file from a file system, retrieving a record from an electronic database, or generating the audio content on-demand via a text-to-speech engine. Indeed, it often will be the case that a plurality of different methods are used to retrieve the audio content, in that audio content read from the file system may be subsequently cached in-memory, or the generated output of a text-to-speech engine may be written to a temporary file on the file system, etc.

The initial instructions to the user of communication device 302 typically prompts the user to interact with the communication device 302 by pressing keys, or by uttering voice commands, which are then transmitted to the Voice Service 310. Upon receipt of a key press, or a sequence of key presses, or voice commands, the Voice Service 310 accesses an electronic Archive Database 312, which maps the key presses or voice prompts into references to audio content that is then retrieved and injected into the media stream that is being transmitted to the communications device 302. Upon completely injecting the retrieved audio content, the Voice Service 310 typically injects additional audio content that represents further instructions to the user of the communication device 302.

In addition to signals received from communication device 302, the Voice Service 310 may also react to other stimuli, such as for instance timers that are set by the Voice Service 310 itself. Such timers typically are set and cleared upon specific conditions, for example; the start of a session, a key press being received from communication device 302, audio content starting to be injected, audio content being completely injected, or upon the expiry of a different timer. In this manner, a Voice Service 310 can implement a variety of functionality, such as repeating an instruction to the user if no key presses have been received within 30 seconds (or another period of time) after the instruction was completely played, interpreting a sequence of key presses as being complete if no additional key presses are received within 3 seconds (or another period of time) of the last key press, interacting with Call Processor 308 to disconnect the call after 2 minutes (or another period of time), continuing to inject additional audio content if no interactions are detected within 5 seconds (or another period of time), etc.

Referring still to FIG. 3, the audio content relating to a specific point of interest (POI), such as for instance an artifact, is stored in an electronic Archive Database 312 as a plurality of distinct fragments. For instance, a first fragment of the plurality of fragments contains a cursory overview of the artifact, and at least a second fragment of the plurality of fragments offers increasing detail or auxiliary information relating to the artifact, such as for instance the history of the artifact, how it was made, how or when it was found, how it was used, why it was chosen for display, etc. Typically, the first fragment of the plurality of fragments is selected to be suitable for a general audience, which includes users of different ages and different educational backgrounds, etc. Optionally, the other fragments of the plurality of fragments are also selected to be suitable for a general audience, but offering additional information relating to the artifact. Further optionally, the other fragments of the plurality of fragments include fragments that are targeted specifically to different audiences.

Each fragment of the plurality of fragments for a particular point of interest is stored in the electronic Archive Database 312 in association with its own unique POI identifier, thereby allowing it to be sequenced, such that the fragments associated with a point of interest can be retrieved in the correct order from the electronic Archive Database 312. Of course, more than one sequence of retrieval may be possible. In addition, different retrieval sequences may have some fragments that are the same and some fragments that are different. Alternatively, all of the fragments are the same and only the order of retrieval is different.

A user of the interactive audio guide system that is shown in FIG. 3 calls into Voice Service 310 using the communication device 302, and is prompted to enter a POI identifier associated with a first point of interest, such as for instance a first artifact. In response to receiving the POI identifier the Voice Service 310 retrieves from Archive Database 312 a first audio fragment associated with the first artifact. When a second audio fragment is also associated with the first artifact, the user is prompted to either select the second audio fragment or enter another POI identifier for another point of interest, such as for instance a second artifact. This process is repeated for each artifact that the user encounters, so as to support an “ad hoc” visit of an exhibit or facility. In this way, the user specifies the level of detail or the amount of ancillary information that is provided for each point of interest, i.e. for each artifact. The user may choose to receive for some artifacts only cursory information (i.e., the first fragment), but choose to receive detailed information for other artifacts (i.e., at least a second fragment). Optionally, the user specifies the default amount of information that is to be provided for each artifact. For instance, the user specifies that by default the first two fragments are to be provided for each artifact without requiring additional input from the user. Of course, the user may interrupt playback of the fragments for any artifact and/or select additional fragments in addition to the first two fragments.

Alternatively, the Voice Service 310 is implemented such that upon completely injecting the audio fragment describing the first point of interest, the Voice Service 310 queries an electronic Tour Database 314 for the next POI identifier in the tour, and retrieves location information for both the current point of interest and the next point of interest from an electronic Location Database 316. This information can then be used to generate or retrieve an audio fragment that instructs the user as to how they may locate the next point of interest, followed by an additional fragment instructing the user to press a key to indicate when they are ready to hear the description that is associated with the next point of interest. If there is no location information in the electronic Location Database 316 for the first point of interest and/or the next point of interest, then a fragment simply stating the POI identifier of the next point of interest may be used in lieu of providing instructions for proceeding thereto. Thereafter, when the Voice Service 310 receives a key press or a voice command from the communication device 302, the Voice Service 310 retrieves the appropriate audio fragment from the electronic Archive Database 312 and injects the audio fragment into the media stream that is being transmitted to the communication device 302. Repeating this process for each one of a plurality of points of interest results in the presentation of a “guided” tour. Multiple guided tours through a same facility are easily supported. For instance, when the user initially establishes connection to Voice Service 310 they are prompted to provide a tour identifier code, either by entering a sequence of key presses or by uttering a voice command. Thereafter, the user is guided from one point of interest to the next according to a predetermined sequence of the selected tour. In particular, the tour identifier is used to query the electronic Tour Database 314 for the next point of interest in the sequence of the selected tour. Different tours may be geared toward different user demographics (i.e., different age groups, etc.) or toward different user interests.

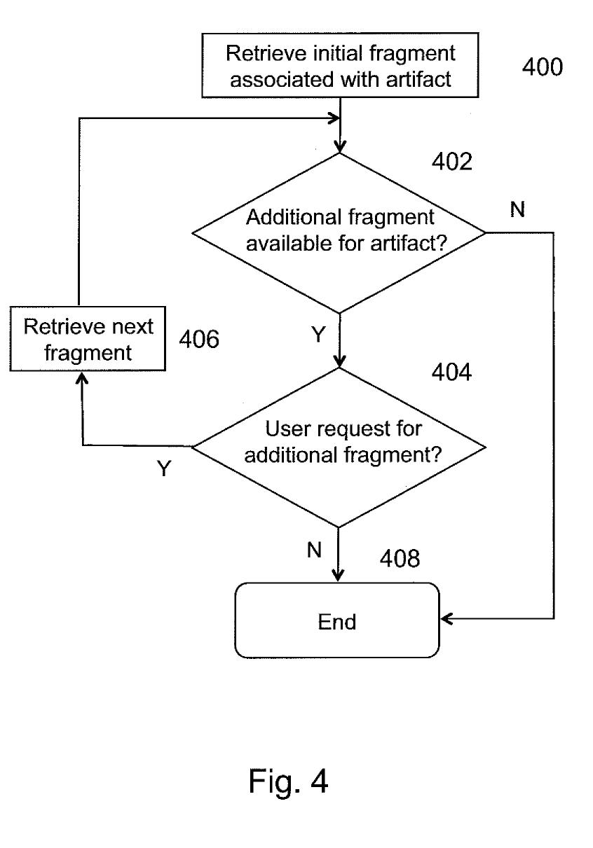

Referring now also to FIG. 4, shown is a simplified flow diagram of a method according to an embodiment of the instant invention. When a user is interacting via a communication device 302 with a Voice Service 310 that implements an audio guide system, as described previously, the audio fragment that is retrieved initially at step 400 from the electronic Archive Database 312 for a particular point of interest, such as for instance an artifact, is the cursory overview of the artifact. If it is determined at step 402 that additional fragments exist (e.g., the history), then the user may request that such additional fragments be retrieved via a simple key press (e.g., ‘#”) or a voice command (e.g., “More.”). Upon determining receipt of user input from communication device 302 at decision step 404, the next auxiliary fragment in a sequence for the artifact is retrieved from the electronic Archive Database at step 306. For instance, the artifact has associated with it a plurality of possible fragments sequences, X, Y and Z, and each one of the fragment sequences has associated with it a plurality of fragments, including a common fragment (the cursory overview) and at least one additional fragment. By way of a specific and non-limiting example, the electronic Archive Database 312 has stored therein the fragments F1, F2, F3, F4, F5 and F6 relating to the artifact, wherein sequences X:F1,F2,F3,F4, Y:F1,F3,F2 and Z:F1,F6 are defined. During use, one of the sequences X, Y and Z is selected to be active, such that the next auxiliary fragment is selected from the active sequence. The process of selecting additional fragments from the active sequence is repeated for as many fragments as exist in the active sequence, or until the user requests no further fragments. In either case the method ends at step 408. Optionally, each fragment in the active sequence is configured to begin playing automatically after a predefined time interval following the completion of the previous fragment in the active sequence, unless the user provides a key press or utters a voice command. Further optionally, the active sequence is determined in dependence upon one or more of an association with a tour identifier associated with the guided tour that the user is taking, a preference indicator contained in a profile record of the user, and a default setting as indicated by the museum or other operator of an exhibit in the absence of any other indications. Optionally, some fragments F5 are not part of any of the predefined sequences, but may nevertheless be requested by the user via key presses entered into the communications device 302. For instance, the fragment F5 relates to a general topic that encompasses the artifact.

Of course, in addition to being able to use a simple key press or voice commands to step through the multiple audio fragments associated with particular artifact, a user also has the option to press a key sequence corresponding to a new artifact identifier. When the user presses the key sequence corresponding to the new artifact identifier, the method loops back to step 400 and the first fragment for the new artifact is retrieved from electronic Archive Database 312 instead of retrieving additional audio fragments about the previous artifact.

If all fragments have been played, or if the user does not within a configurable period of time request more information via the simple key press or voice command, then the Voice Service 310 interprets the stop at a particular point of interest to be finished, and in the case of an “ad hoc” visit, injects an audio fragment into the media stream that instructs the user to enter a new POI identifier; or in the case of a “guided” tour, queries the electronic Tour Database 314, with both the tour identifier and the current POI identifier to retrieve the next POI identifier. The electronic Location Database 316 is then queried with both the current POI identifier and the next POI identifier as described above, in order to generate instructions to the user as to where they can find the next point of interest.

Optionally, at any time during or after the playing of an audio fragment the user, via a simple key press (e.g., ‘7’) or voice command (e.g., “Again.”), instructs the Voice Service 310 to retrieve from the electronic Archive Database 312 the same audio fragment as was just retrieved and re-inject into the media stream. In this manner, fragments can easily be re-played as desired by the user.

Additionally, in the case of a guided tour, at any time during or after the playing of an audio fragment, the user can via a simple key press (e.g., ‘1’) or voice command (e.g., “Next.”) instruct the Voice Service 310 that they are finished with the current point of interest and would like to move on to the next point of interest. Upon receipt of such a key press or voice command, the process is similar to that which occurs when all audio fragments have been retrieved, or the user has failed to indicate via a key press or voice command that they would like to retrieve the next fragment relating to the current artifact.

Referring again to FIG. 3, according to another aspect of the instant invention a record that is stored in the electronic Archive Database 312 for a particular point of interest contains at least a field that is populated with an identifier for linking to additional information that is not associated uniquely with the particular point of interest. For instance, in the specific and non-limiting case of a particular painting there may be additional information that is broadly associated not only with that particular painting but also with other paintings or artifacts, etc., as well. By way of some specific and non-limiting examples, the artist's name, the era, or the painting style may be linked to other information fragments that are not associated uniquely with the particular painting.

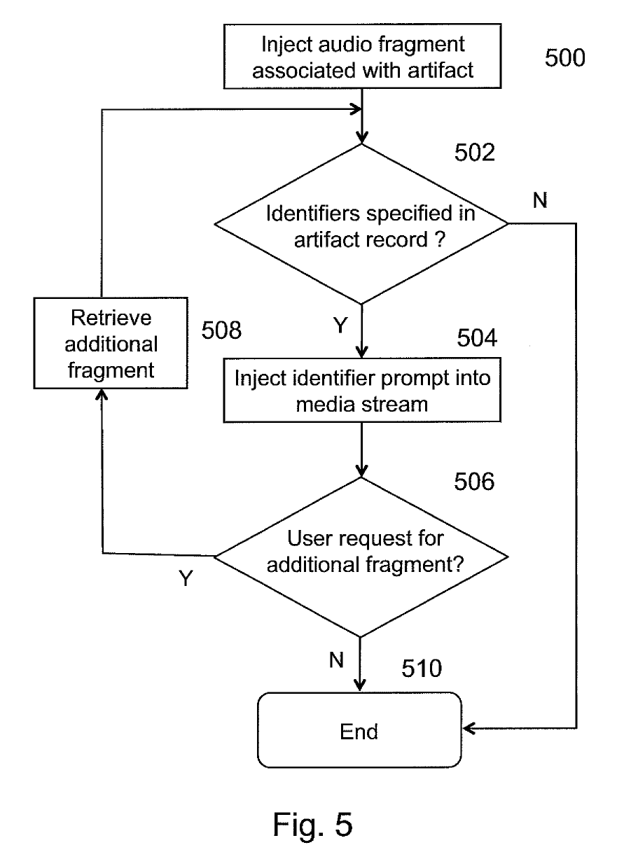

Referring now also to FIG. 5, shown is a simplified flow diagram of a method according to an embodiment of the instant invention. At step 500 an audio fragment that is associated uniquely with a particular point of interest, such as for instance an artifact, is injected into a media stream being provided to a user. For instance, a record is retrieved from electronic Archive Database 312 in response to the user providing a POI identifier that is associated with a particular point of interest, such as for instance an artifact. The record for the artifact contains, or links to, the audio fragment that is associated uniquely with the artifact. At step 502 a determination is made as to whether any identifiers are specified in the retrieved record for the artifact. If it is determined that the record does contain at least an identifier, then at step 504 the Voice Service 310 inserts an audio fragment into the media stream to inform the user that that there is additional information about the artist, or the era, or about any other field, etc., and to instruct the user as to the key press or key presses required to access such additional information. If it is determined at step 506 that the user wishes to receive the additional information, then at 508 an audio fragment associated with the additional information is retrieved from the electronic Archive Database 312 and is injected into the media stream. Optionally, steps 502 through 508 are repeated for each additional identifier that is specified in the retrieved record, or until the user fails to request additional information, at which time the method advances to step 510 and ends.

Furthermore, after retrieval of each fragment from the electronic Archive Database 312, the Voice Service 310 records the occurrence of the retrieval in an electronic History Database 318. This electronic History Database 318 is then queried for each link field associated with an artifact record retrieved from the electronic Archive Database 312, and the if the link fields have been previously retrieved from the electronic Archive Database 312, then the Voice Service 310 does not insert an audio fragment offering the link information.

Additionally, items in the electronic Archive Database 312 may have attributes associated with them (e.g., artist name, subject matter, nationality of the artist, etc.) that can be used to create relationships with other points of interest. Such relationships are determined, for each attribute, by retrieving identifiers from the Archive Database 312 having the attribute associated with the current artifact. This query may optionally be constrained to a field associated with the current tour identifier (if any), so that the query only returns POI identifiers on the current tour. If the query returns a non-empty list of other POI identifiers that share an attribute with the current artifact, then an audio fragment describing the fact that there are other artifacts sharing the same attribute can be injected into the media stream, along with an instruction of the key press or key press sequence or voice command that will enumerate the other artifacts. If the user interacts with the communication device 302 in such a mariner that the Voice Service 310 detects that the user wants to hear the enumeration of other artifacts sharing the attribute, then the Voice Service 310 will, for each other artifact sharing the attribute with the current artifact, query the electronic Location Database 316 with the current POI identifier and the other POI identifier, and construct an audio fragment that will inform the user as to how to find the other artifact. The constructed audio fragment is then injected into the media stream.

Referring again to FIG. 3, according to another aspect of the instant invention user profile data is generated and stored for use in providing information to the user. As described above, a record is created in the electronic History Database 318 when a user interacts with communication device 302 and causes Voice Service 310 to retrieve, from the electronic Archive Database 312, fragments associated with a point of interest, such as for instance an artifact. Additionally, information is stored in the electronic History Database 318 about whether the user requested additional fragments of information about the same artifact, or whether they skipped to the next point of interest in a tour, or whether they requested an enumeration of other points of interest sharing an attribute with the artifact. Based on past user requests and usage patterns, the Voice Service 310 implicitly infers a level of user interest in different points of interest, in dependence upon the amount of information that the user voluntarily requested for each point of interest. Alternatively, the Voice Service 310 injects an audio prompt into the media stream to remind the user that they can, for any point of interest, explicitly indicate their interest therein via a simple key press (e.g., ‘*’) or voice command (e.g., “favorite”). The audio prompt optionally is provided when the user initially connects to the Voice Service 310, or it is repeated throughout a session at intervals. Further optionally, the user is provided an opportunity to quantify a level of interest in a particular point of interest via a key press, such as for instance by pressing one of the keypad keys numbered 0-9.

Using the implicit and/or explicit indications of a user's interest for each one of a plurality of points of interest, or for a group of points of interest, the Voice Service 310 can build up a preference profile of what has interested the user in the past. The preference profile can be used subsequently to query the electronic History Database 318 for other points of interest that have interested other users with similar preference profiles. If there is a strong match, then the Voice Service 310 injects into the media stream an audio fragment indicating that it has a recommendation for the next point of interest to visit. If the user accepts the recommendation, then the electronic Location Database 316 is queried to create instructions as to how the user may locate the next point of interest. After retrieving and injecting fragments associated with a recommended point of interest, the Voice Service 310 optionally injects an audio fragment that prompts the user to indicate, via a simple key press or voice command, whether they thought the recommendation was helpful. In this manner, the preference profile for a user can be fine-tuned over time.

Conversely, during a “guided” tour the Voice Service 310 may select a particular point of interest to be deleted from a predefined tour if the user preference profile suggests that there is a strong likelihood that the user will not find the particular point of interest to be of interest. Optionally, the Voice Service 310 may dynamically reduce the duration of audio fragments relating to those points of interest that are likely to be of lower interest to a user, and at the same time increase the duration of audio fragments relating to those points of interest that are likely to be of higher interest to the user. Accordingly, two users having different preference profiles might progress through the same tour at different instantaneous rates, but still arrive at the end of the tour at approximately the same time. Alternatively, a user may deviate from a predefined tour in order to include a different point of interest, which is not a part of the predefined tour but which may nevertheless be of high interest to the user, possibly requiring the user to skip some points of interest of the predefined tour in order to avoid extending the tour duration beyond a predefined limit.

In addition to merely recommending next points of interest to the user, optionally the Voice Service 310 suggests one tour selected from a plurality of different tours for a same museum or exhibit. For instance, the preference profile is used to query the electronic History Database 318 for tours that have interested other users with similar preference profiles. The tour that is determined to have been most interesting to the other users is then suggested to the user. Of course, the user may accept the suggestion or choose a different tour. The user may also choose to switch to a different tour before completing a current tour, which fact is stored in the electronic History Database 318 and used to update the user's preference profile.

Optionally, the preference profile is used to send reminders or notifications to the user. For instance, a museum may send a notification to the user when it begins a new exhibit that is determined, based upon the user's preference profile, to be potentially of interest to the user. Such notices are transmitted to the user via e-mail or via the communication device 302, etc.

Of course, in order to maintain a user history or preference profile the system must be able to persist information against a specific user. Thus, when a Communication Device 302 connects to the Call Processor 308, the Call Processor 308 analyzes the provided connection information for uniquely identifiable information relating to the specific user. The Voice Service 310 uses this information in a query to an electronic Session Database 320, to retrieve a unique user identifier for associating the specific user with the current, previous and subsequent telephony sessions. If the connection information contains uniquely identifiable information, but the electronic Session Database 320 cannot retrieve a unique user identifier based on the connection information, then a new record is created in the electronic Session Database 320 that associates the Communication Device 302 with the user for the current and subsequent sessions.

For land phone and mobile phones, the calling line identification (CLID) can be used as the uniquely identifiable information, if it is available. For VoIP devices, the SIP address of Record (AOR) or Skype number or equivalent identifier may be used as appropriate.

Alternatively, if the Communication Device 302 does not contain any uniquely identifiable information then the Voice Service 310 injects an audio fragment into the media stream to instruct the user to enter a unique personal identification number (PIN), that is used to identify the user. The Voice Service 310 uses the received PIN, in lieu of connection information extracted by the Call Processor 308, in a query to the electronic Session Database 320 to retrieve the unique user identifier. If the query does not return a record, then the Voice Service 310 injects an audio fragment into the media stream informing the user that no identifier exists for that PIN, and asks the user if they would like to register the PIN as an identifier to be used in subsequent sessions. In this manner, mistyped PIN's do not create a plethora of user identifiers.

If the Communication Device 302 does have uniquely identifiable information, but the query to the electronic Session Database 320 indicates that it is a shared device, such as a portable SIP phone that is rented out by an institution, the Voice Service 310 injects an audio fragment into the media stream to prompt the user for a PIN, which can be used to identify the user with the device for a temporary period, so that the user only needs to enter a PIN once per visit. Alternatively, if the user is not interested in interacting with the system after his visit, the system can automatically assign a new random identifier. This approach requires some notification to the system, either through a point of sale system 350, personal computer 360 or other application including through a Voice Service dialed from Communication Device 302, to disassociate the Communication Device 302 from its previous user. This notification typically occurs on return of a rental unit, or upon delivery the communication device 302 to a new user.

Optionally, the “electronic Databases” are either local or remote. Further optionally, the “electronic Databases” are implemented in a distributed manner and/or communicate with a central database. In this way, the user's preference profile data is fine tuned during visits to any of a plurality of different venues that implement the interactive audio guide service. Furthermore, the user's preference profile data is available during visits to any of the plurality of different venues that implement the interactive audio guide service.

Referring again to FIG. 3, according to another aspect of the instant invention a user of a Personal Computer 360 connects to a Web Server 340 and enters a unique identifier, such as for instance one of the identifier of the Communication Device 302 (if available) or a selected PIN. The Web Server 340 validates the user against the electronic Session Database 322, and then queries the electronic History Database 318 for the points of interest previously observed and preferences previously expressed by the user. The Web Server 340 then constructs a web page itemizing all, or at least a portion of, the visits the user has made to different institutions. The user can then “drill down” on a visit and see a journal of all the artifacts observed during that visit, including text and links to the audio they would have heard during the actual visit. Optionally, the content that is provided to the user from the Web Server 340 is enriched with media that is extracted from an External Web Server 370.

Optionally, the user can interact with the web page after it is constructed in order to modify the journal, so as to remove items, reorder items, or even add items that were not included in the original guided audio tour. When the user adds an item, the Web Server 340 optionally makes use of the insertion point to query the electronic Location Database 316 for nearby points of interest, so as to optimize the selection of points of interest from which the user may choose.

The user can, for each POI identifier that is included in the journal, view and edit the level of interest indicator as either implicitly inferred through analysis of the electronic History Database 318, or as explicitly indicated by the user through interaction with the Voice Service 310.

The user can optionally print out or buy a souvenir record of their visit. For instance, Web Server 340 generates a document that is uploaded to a third-party service, such as viovio.com, blurb.com or photoinpress.ca, to create a possibly hard-bound high-quality book.

Although use of the electronic History Database 318 can be used to automatically create a journal, a user can also interact with the Web Server 340 to create a blank journal, and then add to it artifact identifiers listed in the electronic Archive Database 312.

A user can interact with the Web Service 340 to create a custom guided tour that covers the points of interest listed in the journal, by generating a tour identifier that is stored in the electronic Tour Database 314. When another user connects to Voice Service 310, and enters the custom guide tour identifier, the Voice Service 310 retrieves the artifact identifiers from electronic Tour Database 314 and injects audio retrieved via electronic Archive Database 312, either with or without navigation aids retrieved from electronic Location Database 316. In this manner, the user is able to experience a visit as it was previously experienced, or at least envisaged by, the custom guided tour creator.

Alternatively, tour creation is done through non-web application (e.g., a Windows Vista executable), provided that the application is capable of establishing a connection (e.g., SOAP) to the Knowledge Server 304 that can be used to query and update the electronic Tour Database 314.

Because the electronic History Database 318 associates timestamps with the retrieval of information fragments from the electronic Archive Database 312, the Web Server 340 is able to estimate the amount of time a particular user spends observing a particular point of interest. This initial observation time estimate for a particular point of interest can be made more accurate by building up a statistical model based on the observation times of many different users, with emphasis given to users with similar preference profiles. As other users follow a guided tour, their actual observation times further improve the observation time estimate for each point of interest. By accumulating the observation time estimates for each POI identifier in a guided tour, an overall tour duration estimate may be calculated.

However, since the observation time estimates, as estimated based on the electronic History Database 318, include walking or transportation time between points of interest, the observation estimates are necessarily a function of the sequence in which the points of interest are visited. In this manner, a Web Server 340 may be able to propose an alternative sequence of POI identifiers that optimizes the total tour duration estimate.

The guided-tour creator optionally uses estimated tour duration data as the basis for recording in electronic Tour Database 314 a time budget, within which other users must complete the custom guided tour. As other users follow the custom guided tour, an individual factor may be calculated by comparing the observation times at each artifact with the estimated observation times. In this manner, the time it will take one of the other users to complete the rest of the custom guided tour may be estimated by summing the estimated observation times of the remaining points of interest and multiplying the sum by that other user's individual factor. If the other user's completion-time estimate is greater than the specified time budget, less the time elapsed since the other user started the custom guided tour, then it can be determined that the other user is unlikely to finish the custom guided tour within the specified time budget.

For a custom guided tour with a specified time budget, the Voice Service 310 optionally accelerates a user's progress through the custom guided tour by retrieving estimated observation times for the remaining items in the custom guided tour, and flagging a number of points of interest as candidates for omission from the user's progress through the custom guided tour. The Voice Service 310 then retrieves from the electronic Tour Database 314 the next POI identifier that has not been flagged as a candidate for omission.

As each point of interest is visited, the other user's individual factor is constantly updated, so that if the other user's individual factor decreases, some of the points of interest omission flags can be cleared. Similarly, if the other user's individual factor increases, more points of interest may have to be flagged for omission.

The number of points of interest that need to be flagged for omission is such that the flagged points of interest estimated observation times multiplied by the other user's individual factor are greater than the time budget overrun. Selection of which remaining points of interest in the custom guided tour get flagged for omission is based on level of interest, as specified by the custom tour creator, such that points of interest identified as more interesting are not flagged for omission as long as there are less interesting ones that can be flagged.

If a choice to flag for omission must be made between multiple points of interest of the same level of interest, as specified by the custom tour creator, then the other user's preference profile is used to ensure that the pieces most likely to interest that user are not flagged for omission.

If neither the custom tour creator's specified level of interest or the other user's preference profile suggests clear choices for flagging for omission, then a number of heuristics can be used, i.e., sorting by increasing estimated observation times the remaining points of interest, and then selecting as many items from the beginning of the sorted list as is required to accommodate the time budget overrun. In this manner a lot of points of interest with short estimated observation times are omitted, thereby preserving fewer points of interest with longer estimated observation times in the custom guided tour. Similarly, the remaining points of interest can be sorted by decreasing estimated observation times, so that the smallest number of points of interest, each with a relatively long estimated observation time, is flagged for omission. Optionally, the electronic Location Database 316 is queried such that points of interest are sorted by increasing (or decreasing) estimated observation time within each gallery or room, so that the omissions are distributed across multiple areas within an institution. Even random or decimation may be used as a means of selection.

An alternative approach to accelerating tours by omitting some points of interest is to reduce the observation time of each subsequent point of interest by accelerating the delivery of the audio fragments. This can be done by eliminating or skipping a percentage of audio packets (e.g., 10 ms of audio) such that the speech sounds faster, but since entire packets are deleted, the apparent pitch of the speaker is not affected. Audio distortion of such acceleration can be minimized by preferentially discarding packets with the least energy.

If the audio fragments are generated via text-to-speech engine, then optionally a speed parameter that affects the speech synthesis is changed from a default value for normal play-back to a different value for accelerating play-back, accomplishing the same goal without discarding audio packets. Optionally, the value of the speed parameter is set to one of a plurality of accelerated play-back values, so as to achieve a desired play-back acceleration within a range of supported play-back accelerations.

As an alternative to or in conjunction with handling tour budget overruns by omitting specific points of interest, or by accelerating audio play-back, optionally the Voice Service 310 injects an audio fragment into the media stream that reminds the user that he is progressing slower than expected, and must increase pace in order to observe all of the points of interest within the allotted time budget.

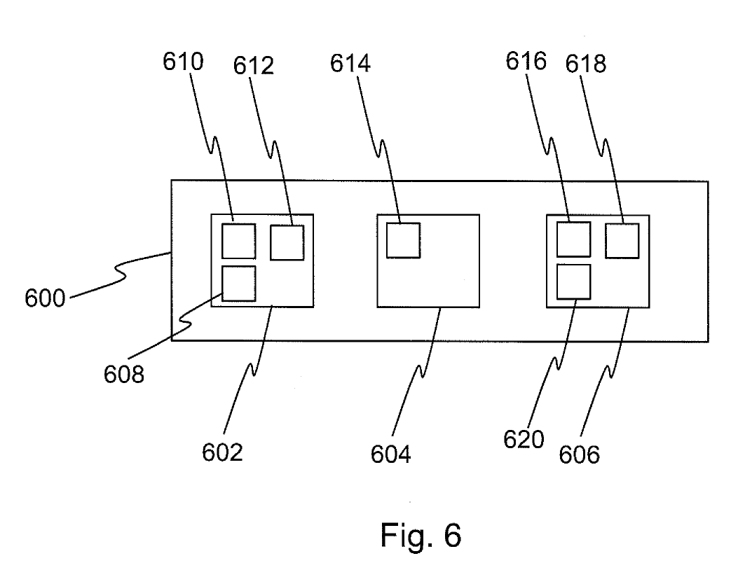

Referring again to FIG. 3, according to another aspect of the instant invention before visiting an institution, a user interacts with Web Server 340 to specify that they would like to participate in a sequence tours, not necessarily at the same institution. Referring now also to FIG. 6, shown is an example sequence of tours, in which the box 600 represents a user's “top level” tour of a particular country or, alternatively, a tour of a particular region. When the user is traveling by air to the country or region, the beginning and end points in time for touring the country or region are substantially fixed. Thus, the user must accommodate component tours, such as for instance tours of cities or sub-regions 602, 604 and 606, within a fixed amount of time that is budgeted for the entire “top level” tour. Additionally, the user has identified a next level of component tours in the form of a plurality of museums, exhibits or other venues 608-620, which they wish to visit. Conveniently, a tour may be set up for the user in a manner that is analogous to the example that was described previously with respect to a tour of a museum. Referring still to FIG. 6, the top level tour is constructed to allow a predetermined amount of time budgeted for each city or region 602-606, and furthermore the time that is budgeted for each city or region 602-606 is further allocated amongst the different venues 608-620. Although not shown in FIG. 6, a guided-tour of the points of interest and displays contained in each of the venues 608-620 may also be constructed for the user. Provided that the user adheres to the time line of the tour as constructed, it is highly likely that the user will be able to visit all of the identified components of the tour right down to specific points of interest or displays in each museum, exhibit or venue. As with the estimation of observation times, each component tour can have associated therewith an estimated duration, and the same concepts of acceleration that have been discussed above can be applied to each component tour in the sequence. In this way, if the user deviates from the time line of the tour as constructed, then for instance a component tour can be omitted, or can have its time budget reduced to compensate for earlier component tours that went over their time budget. As a result, the user fills their time efficiently and substantially completely until a designated ending time of the “top level” tour.

Similarly, the same approach to optimizing the estimated duration of a tour can be used to optimize travel time across multiple component tours, and can take into consideration that some components have fixed times. For example, a reservation to an IMAX® show at 2:00 pm means that there are 5 hours to explore before the IMAX® showing and 1.5 hours to explore after the IMAX® showing, which means that putting two long component tours before the IMAX® showing, and one short tour after the IMAX® showing is a more efficient use of time than putting a long and a short component tour before the IMAX® showing, and then rushing a long tour after the IMAX® showing.

Referring again to FIG. 3, according to another aspect of the instant invention a user who has created a custom guided tour via interaction with the Web Server 340 optionally creates text or edits the existing text associated with some or all of the entries in the supporting journal. The created or edited existing text is then stored as information fragments in the electronic Archive Database 312, associated with both the POI identifier and the tour identifier. In this manner, audience-specific content is created that reflects subject matter interest, age or educational background, or religious or political inclinations, etc.

In a similar manner, custom audio fragments for any POI identifier in a custom guided tour can be uploaded and stored in the electronic Archive Database 312, so that when an other user enters the identifier of a custom guided tour, the Voice Service 310 retrieves, whenever possible, the custom audio fragments rather than the default audio fragments. This supports user-provided translations of text into languages not normally supported by the institution, or providing celebrity voice talents, etc.

When a POI identifier and tour identifier result in the Voice Service 310 retrieving custom text from the electronic Archive Database 312, but no audio fragment, the text is automatically converted into audio fragments via a text-to-speech engine.

Referring again to FIG. 3, according to another aspect of the instant invention when a uniquely identifiable Communication Device 302 or a non-uniquely identifiable Communication Device 302 in conjunction with a unique PIN are used to establish an identity of a user, the Voice Service 310 queries the electronic History Database 318, to retrieve the tour identifiers that were used to retrieve information from the electronic Archive Database 312. Each tour identifier is then used to retrieve the point of interest tour identifiers from the electronic Tour Database 314, which are compared with the observed point of interest identifiers to determine if the tour was finished. If this check reveals that a tour previously started was not completed, the Voice Service 310 injects an audio fragment into the media stream that offers the user the ability to interact with the Communication Device 302 via either a key press or voice command and indicate whether they would or would not like to continue the unfinished tour.

An affirmative indication from the user obviates the need for the Voice Service 310 to collect digits for a tour identifier.

Alternatively, a user can enter a special tour code that the Voice Service 310 uses in conjunction with the electronic Archive Database 312 and the electronic History Database 318, to dynamically create a tour consisting of the points of interest in the institution, which the user has not previously observed.

Conveniently, if a user associates with their Communication Device 302 a credit card number, or an alternate electronic payment account such PayPal®, then the Voice Service 310 accesses an electronic Commerce Database 330 to search for purchasable items that are related to a current point of interest. If it is determined that there are purchasable items related to the current point of interest, then the Voice Service 310 injects audio whenever the user appears to be interested in the item, either through implicitly inferred or expressly indicated interest, or through a previously defined preference profile. Purchasable items are related to an identifier through one or more of a point of interest title, artist name, or other attributes, such as for instance the era or artist affiliation, etc. Optionally, the credit card number or alternate electronic payment account is associated permanently with communication device 302. Alternately, the credit card number or alternate electronic payment account is associated with communication device 302 for only the current session being undertaken by the user.

Items purchased through an interaction with Communication Device 302, via a key press or voice command, result in the merchandise optionally being shipped directly to the user's home address as provided in the users profile, or put aside in the museum store for quick pickup, or delivered directly to the user's room in a theme park hotel, etc.

Additionally, if an institution has an associated bricks-and-mortar store, this store can be assigned an identifier, which if entered by the user, can be used by the Voice Service 310 to initiate a query of the electronic Commerce Database 330 for all items that correspond to the points of interest with a high level of interest as inferred implicitly or indicated explicitly, or previously determined in the user preference profile. The Voice Service 310 can then inject audio fragments into the media stream that make suggestions for merchandise that the user is likely to prefer.

Further optionally, the Web Server 340 can integrate with a micro-blogging technology such as twitter, such that posts can be sequenced with entries in the electronic History Database 318. If the user specifies the POI identifier in the posting, then the electronic History Database 318 can infer that the user has visited a piece, even though the user never retrieved information from the electronic Archive Database 312 by specifying the POI identifier via the Communication Device 302. The text of posts can be included in a journal, created from records in the electronic History Database 318.

According to an aspect of the invention, when a user has a persisted identity in the electronic Session Database 320, and there is a unique identifier for Communication Device 302, the Voice Service 310 can initiate an outbound call to Communication Device 302 and upon acceptance of the call by the user, can inject audio into the media stream that informs the user of items relating to the user's preference profile. For example, four weeks prior to the departure of a temporary exhibit, the Knowledge Server 304 queries electronic Session Database 320 for all users who would likely enjoy the exhibit, and reminds them of their last opportunity to see the exhibit. Similarly, new exhibits can be promoted. This approach can be used by an institution to not only boost their numbers, but to pace visitors to the institution throughout the week and month, by adapting the number of out-bound reminder calls to reflect the number of visitors.

The methods and system described above also support collaborative interaction between users. For instance, typically when Communication Device 302 and Communication Device 380 call into the Knowledge Server 304, they both have completely independent user experiences, in that the users of each device can enter POI identifiers independently or can follow separate tours. However, if the Voice Service 310 prompts each user for an identifier such as a PIN or a CLID, the two sessions can be linked together in electronic Session Database 320. From that point on, digits and voice commands received from Communication Device 302 invoke a response in Voice Service 310, typically through the injection of audio fragments retrieved from electronic Archive Database 312, into the media streams for both Communication Device 302 and Communication Device 380. As well, most other information and prompts such as requests for the next POI identifier, or a guide tour's description of the location of the next point of interest in the tour are injected into the media streams of Communication Device 302 and Communication Device 380.

However, while interaction with linked Communication Device 302 causes Voice Service 310 to inject audio into the media streams of Communication Device 302 and linked Communication Device 380, it is not necessary that the injected audio is identical for all linked devices. For instance, a user's preference profile optionally includes a preferred language, which is then used when retrieving audio fragments from the electronic Archive Database 312. In this manner, a group of users with different language preferences can visit an institution together and share the same experience, but each hears the audio in their language of choice. Similarly, the preference profile for the user of linked Communication Device 380 may indicate visual impairment, or age, or other attributes that indicate a need to retrieve specialized content when retrieving audio fragments from the electronic Archive Database 312, so that when a POI identifier is entered by either of the linked communication devices, the Voice Service 310 retrieves and injects specialized audio fragments for Communication Device 380 and default audio fragments for injection into Communication Device 302.

The Voice Service 310 optionally directs media streams received from linked communication devices to an Audio Mixer 322, which functions as a conferencing unit, so that audio received by the microphone of Communication Device 302 and the microphone of Communication Device 380 can be mixed along with the audio injected into the media stream of Communication Device 390, etc., by the Voice Service 310. Similarly, Communication Device 302 receives an audio stream that is the mixing of audio streams received by the microphones of Communication Devices 380 and Communication Device 380, as well as the audio fragments injected by Voice Service 310. In this manner, multiple users can talk to each other, or collaborate by asking each other questions and have the answer heard by all, but all injected fragments are specific to each user as per each user's language or other preference.

The collaboration aspect of linked devices also allows users to be geographically separate, and can facilitate for example a shared experience watching a professional sports game in which some users are at the stadium, and others are watching from home. In this example, any of the users of the linked devices can enter the jersey number of one of the players, and all can listen to the retrieved information, which can include links to related information such as player history, or team overview, etc. and all the while the users can discuss what they are hearing or seeing while watching the game.

Although the various databases are shown separately in FIG. 3, it is to be understood that optionally all of the databases are stored in a same memory device of the host system knowledge server, or some of the databases are stored in different memory devices of the host system knowledge server. Further optionally, some of the databases may be located centrally, whilst other ones of the databases are maintained locally at the institution that is hosting an exhibit.

Of course, in addition to audio content other forms of video and/or text content may also be provided in an analogous manner.

Numerous other embodiments may be envisaged without departing from the scope of the instant invention.

What is claimed is:

1. A method for providing audio content to a user, the user being uniquely associated with a mobile communications device that is in wireless communication with a host system via a communications network, the method comprising:
receiving from the user via the communications network a request for audio content relating to a known point of interest (POI), the request including a unique user identifier associated with the user and a unique POI identifier associated with the known point of interest;
retrieving from a first storage device of the host system, profile preference data that are stored in association with the unique user identifier, the profile preference data relating to at least one predefined preference of the user;
retrieving a first audio content fragment from a second storage device of the host system, the first audio content fragment selected from a plurality of available audio content fragments in dependence upon the retrieved profile preference data and the unique POI identifier; and,
providing to the user via the communications network the retrieved first audio content fragment.

2. A method according to claim 1, wherein the first storage device and the second storage device are a same storage device.

3. A method according to claim 1, wherein the profile preference data relate to an interest of the user.

4. A method according to claim 1, wherein the profile preference data relate to an accessibility preference of the user.

5. A method according to claim 1, wherein the profile preference data are based on a history of the user's past requests for audio content relating to other known points-of-interest.

6. A method according to claim 1, wherein the profile preference data are based on a history of the user's past rating-indications of audio content relating to other known points-of-interest.

7. A method according to claim 1, comprising providing a second audio content fragment relating to the known POI prior to receiving the request for audio content from the user, and wherein the first audio content fragment includes audio content that is supplemental to the second audio content fragment.

8. A method according to claim 1, comprising providing a second audio content fragment relating to the known POI, the second audio content fragment provided in response to receiving a second request from the user via the communications network for audio content relating to the known POI, and wherein the second audio content fragment includes audio content that is supplemental to the first audio content fragment.

9. A method for providing audio content to a user via a mobile communications device that is in wireless communication with a host system via a communications network, the method comprising:
receiving from the user via the communications network a request for audio content relating to a known point of interest (POI), the request including a unique POI identifier associated with the known point of interest;
retrieving from a storage device of the host system a default first audio content fragment that is stored in association with the unique POI identifier;
providing to the user via the communications network the retrieved default first audio content fragment;
receiving from the user via the communications network a request for audio content that is supplemental to the default first audio content fragment;
retrieving from the storage device of the host system a second audio content fragment that is linked to the default first audio content fragment; and,
providing to the user via the communications network the retrieved second audio content fragment.

10. A method according to claim 9, wherein the second audio content fragment is stored in association with the unique POI identifier of the known point of interest.

11. A method according to claim 9, comprising prior to receiving from the user via the communications network a request for audio content that is supplemental to the default first audio content fragment, providing to the user via the communications network an indication that audio content supplemental to the default first audio content fragment is available.

12. A method according to claim 9, wherein the second audio content fragment is selected based on profile preference data of the user.

13. A method according to claim 9, wherein the second audio content fragment is stored in association with the unique POI identifier of the known point of interest and in association with a unique POI identifier of at least one other known point of interest.

14. A method according to claim 9, wherein the second audio content fragment is a next audio content fragment of a predefined sequence of audio content fragments, each audio content fragment of the predefined sequence stored in association with the unique POI identifier of the known point of interest.

15. A method for providing audio content to a user, the user being uniquely associated with a mobile communications device that is in wireless communication with a host system via a communications network, the method comprising:
for each point of interest of a plurality of different points of interest, providing to the user via the communications network at least one audio content fragment;
determining for each point of interest of the plurality of different points of interest, a user interest score relating to the provided at least one audio content fragment; and,
storing data defining a user preference profile, the data stored in association with a unique user identifier of the user, the data comprising first data based on the determined user interest score for each point of interest of the plurality of different points of interest.

16. A method according to claim 15, wherein the user interest score relating to the provided at least one audio content fragment is determined based on a user-initiated signal, the user-initiated signal including an indication of the user's level of interest in the provided at least one audio content fragment.

17. A method according to claim 15, wherein the user interest score relating to the provided at least one audio content fragment is determined based on the user's implicit response to the provided at least one audio content fragment.

18. A method according to claim 15, wherein storing data defining a user preference profile comprises storing second data relating to an area of interest specific to the user.

19. A method according to claim 15, wherein storing data defining a user preference profile comprises storing second data relating to accessibility preferences of the user.

20. A method according to claim 19, wherein the second data relating to accessibility preferences of the user is indicative of a language preference of the user.

21. A method according to claim 19, wherein the second data relating to accessibility preferences of the user is indicative of a visual impairment of the user.

22. A method for providing audio content to each user of a plurality of different users, each one of the users being associated uniquely with a different mobile communications device that is in wireless communication with a host system via a communications network, the method comprising:
associating a first user of the plurality of different users with a second user of the plurality of different users;
receiving from the first user via the communications network a request for audio content relating to a known point of interest (POI), the request including a unique POI identifier associated with the known point of interest;
retrieving at least a first audio content fragment from a storage device of the host system, the at least a first audio content fragment selected from a plurality of available audio content fragments in dependence upon at least the unique POI identifier; and,
providing the at least a first audio content fragment to the first user and to the second user, absent the second user providing a request for audio content relating to the known point of interest.

23. A method according to claim 22, wherein the first user has a first unique user identifier associated therewith and the second user has a second unique user identifier associated therewith.

24. A method according to claim 23, wherein the request includes an indication of the first unique user identifier.

25. A method according to claim 23, wherein retrieving at least a first audio content fragment comprises:
retrieving a first audio content fragment in dependence upon the unique POI identifier and the first unique user identifier; and,
retrieving a second different audio content fragment in dependence upon the unique POI identifier and the second unique user identifier.

26. A method according to claim 25, wherein providing the at least a first audio content fragment to the first user and to the second user comprises:
providing the first audio fragment to the first user; and,
providing the second different audio fragment to the second user.

27. A method according to claim 22, comprising:
subsequent to providing the at least a first audio fragment, providing a second audio fragment from the mobile communications device of the second user to the mobile communications device of the first user, the second audio fragment comprising speech data captured by the mobile communications device of the second user.

28. A method for providing tour-related audio content to a user, the user being uniquely associated with a mobile communications device that is in wireless communication with a host system via a communications network, the method comprising:
defining a tour having a predetermined duration, the tour comprising a plurality of component tours that in aggregate have a total duration of less than or equal to the predetermined duration;
receiving data relating to progress of the user through a first component tour of the plurality of component tours;
determining an expected tour duration based on the total duration of the component tours and the received data relating to progress of the user through the first component tour;
when the expected tour duration is greater than the predetermined duration, accelerating the delivery of tour-related audio content to the user,
wherein the delivery of tour-related audio content is accelerated by an amount that is sufficient to decrease the expected tour duration to less than or equal to the predetermined duration.

29. A method according to claim 28, wherein accelerating the delivery of tour-related audio content comprises omitting the delivery of some of the tour-related audio content.

30. A method according to claim 29, wherein omitting the delivery of some of the tour-related audio content comprises deleting a second component tour that is subsequent to the first component tour, such that an expected tour duration absent the second component tour is less than or equal to the predetermined duration.

31. A method according to claim 30, wherein selection of the second component tour is based on preference data provided by a creator of the tour.

32. A method according to claim 30, wherein selection of the second component tour is based on preference data of the user.

33. A method according to claim 28, wherein accelerating the delivery of tour-related audio content comprises changing a play-back rate of the tour-related audio content.

34. A method according to claim 33, wherein changing a play-back rate of the tour-related audio content comprises changing a play-back rate of audio content during a remaining portion of the first component tour.

35. A method according to claim 33, wherein changing a play-back rate of the tour-related audio content comprises changing a play-back rate of audio content during at least a second component tour that is subsequent to the first component tour.

36. A method according to claim 28, wherein each component tour supports delivery to the user, via the communications network, of audio content relating to a plurality of different points of interest, and wherein some of the plurality of different points of interest have associated therewith a plurality of audio content fragments, the plurality of audio fragments each having a different play-back duration and being retrievably stored in a storage device of the host system.

37. A method according to claim 36, wherein accelerating the delivery of tour-related audio content comprises selecting, for at least some of the plurality of different points of interest, audio fragment having a play-back duration that is less than a maximum play-back duration value.

38. A method for defining an audio-guided tour for providing audio content from a host system to a user via a communications network, the method comprising:
establishing communication between a tour-creator's mobile communication device and the host system via the communications network;
defining points of interest (POT) of the audio-guided tour, the defined points of interest selected from a plurality of known points of interest, each known point of interest having at least an audio content fragment stored on the host system in association with a unique POI identifier thereof, the selection of each of the points of interest being executed in dependence upon providing, using the tour-creator's mobile communication device, the unique POI identifier associated therewith;
for each of the defined points of interest, selecting at least one audio content fragment that is to be provided during the audio-guided tour in response to the user providing a request including the unique POT identifier associated therewith; and,
retrievably storing on the host system a record in association with a unique tour identifier of the audio-guided tour, the record comprising data indicative of the defined points of interest and of the selected audio content fragments.
